(19) United States
(12) Patent Application Publication
(10) Pub. No.: US 2023/0322322 A1
(43) Pub. Date: Oct. 12, 2023

(54) Method For Providing an Adaptive Mobility Solution, and Associated Vehicle

(71) Applicant: Bayerische Motoren Werke Aktiengesellschaft, Muenchen (DE)

(72) Inventor: Werner Haumayr, Neuried (DE)

(21) Appl. No.: 18/041,763

(22) PCT Filed: Aug. 31, 2021
(86) PCT No.: PCT/EP2021/073972

§ 371 Date: Feb. 15, 2023

(30) Foreign Application Priority Data
Sep. 15, 2020 (DE) 10 2020 123 981.5

(51) Int. Cl. B62J 50/26; B62J 45/20; B62M 6/45

(52) U.S. Cl. CPC B62J 50/26; B62J 45/20; B62M 6/45

(57) ABSTRACT

A method for providing an adaptive mobility solution for a vehicle which can represent different vehicle types includes detecting a current position of the vehicle, and calculating a route from a start point (A) to a destination point (B) such that specifications to fulfill permission for traveling the route or route sections thereof are determined therefrom. The route calculation taking place such that road types which are permitted for different vehicle types are not excluded. The method further includes adapting the vehicle type, such as a drive and a display of a license plate, in a manner which is dependent on a route section of the route which is currently being traveled, such that the specifications determined therefor for traveling the route section are fulfilled.

The present application is the U.S. national phase of PCT Application No. PCT/EP2021/073972, filed on Aug. 31, 2021, which claims priority of German patent application No. 10 2020 123 981.5, filed on Sep. 15, 2020, which is incorporated herein by reference in its entirety.

### TECHNICAL FIELD

The disclosure relates to a method for providing an adaptive mobility solution, and to an associated vehicle.

### BACKGROUND

There are a very wide variety of means of transportation which can or have to be used to get from one location to the next location if one wishes to use neither passenger cars nor motorcycles. Depending on the destination and means of transportation, it is sometimes necessary here to change into a different means of transportation. A large amount of time is frequently lost here if, for example, the means of transportation is unpunctual or a relatively long time has to be accepted for changing, for example on account of the schedule.

### SUMMARY

It is therefore an object of the disclosure to provide a mobility solution, in the case of which a user can get from his/her start point to a destination point using a single vehicle, without having to carry out the necessity here of a modality change of his/her means of mobility. This object is achieved by the features of the independent patent claims. Advantageous refinements are the subject matter of the dependent claims.

A method for providing an adaptive mobility solution for a vehicle which can represent different vehicle types is proposed, the method comprising: detecting of a current position of the vehicle, and calculating of a route from a start point to a destination point in such a way that specifications to fulfill permission for traveling the route or route sections thereof are determined therefrom, the route calculation taking place in such a way that road types which are permitted for different vehicle types are not excluded, and adapting of the vehicle type, comprising at least drive and display of a license plate, in a manner which is dependent on that route section of the route which is currently being traveled, in such a way that the specifications determined therefor for traveling the route section are fulfilled.

By way of the proposed method, a vehicle which is likewise claimed and can have its vehicle type adapted can be used to drive on any road type, that is to say cycle route systems and sidewalks open to cyclists, and roads provided for motor vehicles such as rural roads, highways and roads in built-up areas (towns, villages, etc.). That is to say, it is no longer necessary for the driver or user to change his/her means of transportation, that is to say the vehicle, if the route to be traveled cannot be used by a single vehicle in accordance with the prior art.

It is provided, furthermore, that the adapting of the vehicle type takes place in such a way that the vehicle is adapted to become a bicycle or an electric bicycle, comprising an s-pedelec and/or an e-bike, or a motor vehicle. That is to say, the drive operates as a stand-alone drive with or without restriction of the drive power, or it operates as an auxiliary drive with or without restriction of the drive power. It is advantageously provided that a restriction of the drive power takes place in such a way that a maximum speed prescribed for the route section which is currently being traveled cannot be exceeded by the vehicle. Depending on the type of adaptation, different requirements for using a road can be fulfilled. In the case where the drive operates as an auxiliary drive with or without restriction of the drive power, it can also be switched off completely, that is to say provide no assistance at all for the user.

It is provided, furthermore, that a license number is displayed or is concealed in a manner which is dependent on the route section which is currently being traveled and the specifications which are determined therefor. For certain route sections, registration as a motor vehicle and therefore a license number (number plate) are stipulated. Since the vehicle is also allowed to use these roads and therefore officially has a registration, a number plate can therefore be displayed as required. Advantageously, a license plate is displayed in an analog or digital manner in the case where the license plate is displayed.

It is provided, furthermore, that the adaptation of the vehicle type is set to a predefined basic setting or to the last, reliably detected specifications in the case where specifications to fulfill permission for traveling the route or route sections are not detected or not detected unambiguously, for example because the GPS signal is not present or is not sufficiently present, in order to determine the current position of the vehicle.

It is provided, furthermore, that adaptation options of the vehicle type of the vehicle are enabled or denied in a manner which is dependent on a determined authorization of a current user. In one embodiment, the adaptation of the vehicle type is set to a predefined basic setting which allows the vehicle to be driven even without authorization, or driving of the vehicle is refused in the case where the determination of the authorization of the user does not take place or does not take place unambiguously.

It is provided, furthermore, that it is necessary for an adaptation of the vehicle type to be confirmed by a current user.

Furthermore, an adaptive mobility solution, formed as a vehicle which has at least two wheels, is proposed, comprising at least one seat, a handlebar, and front and rear lights, at least one mechanically operated drive which is operatively connected to at least one wheel of the vehicle, can drive this wheel, and acts as a sole or auxiliary (if there are pedals or a hand crank for moving the vehicle with muscular power) drive. The vehicle is configured to be capable of having its properties adapted in such a way that it can represent different vehicle types which are allowed to move on different road types. For this purpose, it comprises: a display unit which is configured and arranged in such a way that it can display or conceal a license number, a control device which is configured to carry out the described method which is preferably implemented as a computer program. The control device contains data about the vehicle types which the vehicle can represent, has a communications link to the drive and to the display unit and transmits control signals to the former in order to adapt its drive power, and in order to display or to conceal the license plate, respectively. Moreover, the control device serves as a navigation device for route calculation.

It is provided, furthermore, that the display unit displays or conceals the license plate mechanically by means of an actuator which can be actuated by the control device, or that the display unit is a digital display, on which the license plate is displayed or concealed.

It is provided, furthermore, that the drive is an electric drive which can be operated by means of a hand or foot throttle. In addition or as an alternative, it is provided that the drive is additionally configured to supply the control device and/or the display unit and/or a lighting system of the vehicle and/or of the display unit with electric energy.

It is provided, furthermore, that the control device is arranged on a front region of the vehicle in the field of vision of a user, and is formed as a separate control device. As an alternative, a mobile device of the user can serve as control device.

It is provided, furthermore, that the front and/or the rear light serve/serves as a turn signal. It is provided as an alternative that a separate turn signal is arranged on the vehicle. In addition or as an alternative, it is provided that the display unit has an integrated lighting system.

It is provided, furthermore, that a monitoring device is provided which is arranged in the field of vision and operation of a user, preferably on the handlebar, in such a way that it serves as a display for which vehicle type and/or which maximum permitted speed are/is currently set. In addition or as an alternative, it is provided that the monitoring device serves as a manual setting possibility for the vehicle type and/or the maximum permitted speed of the vehicle. In addition or as an alternative, it is provided that the monitoring device serves as a confirmation means, in order that the user confirms the vehicle type which is currently proposed by the control device and is to be set.

It is provided, furthermore, that the vehicle is a single-track or multiple-track vehicle with two, three or four wheels. In addition or as an alternative, it is provided that the width of the vehicle is selected in such a way that it does not exceed the maximum permitted overall width for traveling on cycle paths. In addition or as an alternative, it is provided that a canopy for protecting a user and/or the control device is arranged on the vehicle.

Further features and advantages result from the following description of exemplary embodiments, and the accompanying drawings. The individual features can be realized in each case individually per se or in multiples in any desired combination in different embodiments.

### BRIEF DESCRIPTION OF THE DRAWINGS

Preferred embodiments will be explained in greater detail in the following text on the basis of the appended drawing.

FIG. 1 shows a diagrammatic illustration of a journey with and without the proposed, adaptive mobility solution in accordance with one embodiment.

FIG. 2 shows a vehicle 100 in accordance with one embodiment which can be adapted in terms of its vehicle type.

A vehicle 100 and a method provide a novel, adaptive mobility solution, by way of which it is made possible for a distance from a start point A to a destination point B to be covered without changing, that is to say without a change in the type of transportation or means of transportation. The vehicle 100 is therefore preferably configured in the form of a bicycle which can be adapted in terms of its vehicle type in such a way that it is allowed to use as far as possible all road types, that is to say not only cycle paths or sidewalks open to bicycles, but rather also roads up to highways.

Up to now, it can be the case that a person, for example on the way to work, has to carry out multiple changes in the type of transportation if start point A and destination point B are too far apart from one another to use, for example, a bicycle or an electric bicycle, and if this person wishes to use neither a passenger car or a motorcycle to cover the entire distance between start point A and destination point B.

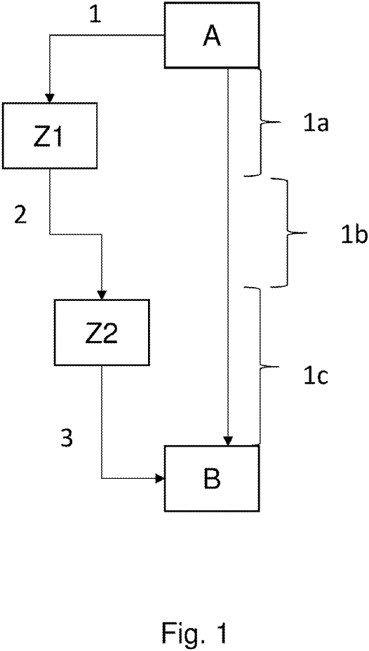

This is shown in simplified form on the left in FIG. 1. It can be the case, for example, that a distance of 40 km or more has to be covered. This can be unsuitable for the use of a bicycle or electric bicycle on account of the length of the distance or else on account of the possibilities for route use (that is to say, the route to be traveled). Therefore, a plurality of types of means of transportation have to be utilized, a first distance 1 starting from home as start point A being covered, for example, by bicycle, passenger car, motorcycle or on foot as far as a bus as first intermediate stop Z1. The bus is then utilized as far as a (suburban) railway station (distance 2 with intermediate stop Z2) in order to utilize the railway or suburban railway. It can be the case here that a change from one (suburban) railway line to another (suburban) railway line has to be carried out once or even multiple times, even with a walk or bus journey between two stations, in order to arrive in the vicinity of the destination location or destination point B. It can then be the case that a distance 3 still has to be covered on foot, in order to finally arrive at the destination point B.

Depending on the degree of fitness and the type of work at the destination point B, a bicycle can be used to get to the destination point B. This is no longer appropriate, however, above a certain distance length between the start point A and destination point B, since the required time for traveling the distance takes too long. As an alternative, an electric bicycle can be used for relatively long distances. Here too, however, the distance length which can be covered between the start point A and destination point B is restricted on account of the limitation of the speed. Moreover, restrictions with regard to permitted routes and roads have to be considered both in the case of the bicycle and in the case of the electric bicycle, with the result that the distance length between the start point A and the destination point B is partially considerably longer than if it were covered with a motor car or motorcycle. This can be the case solely on account of the restrictions for use of a rural road or highway.

In the following text, the vehicle types which are currently defined in accordance with the corresponding legal guidelines are briefly described:
bicycle: vehicle which can be operated substantially purely using muscular force or using muscular force and electric assistance. This includes:
   “normal” bicycles, that is to say a vehicle with at least two wheels which is driven exclusively by the muscular force of persons situated thereon with the aid of pedals or hand cranks (§63a(1) StvZO [German Road Traffic Licensing Regulations])
   pedelecs: Pursuant to (§63a(1) StvZO [German Road Traffic Licensing Regulations]), a vehicle which is equipped with an electric pedal assistance means which is equipped with an electric motor auxiliary drive with a maximum continuous rated power of 0.25 kW is considered to be a bicycle, the assistance of which auxiliary drive is decreased progressively as the vehicle speed increases and is interrupted when a speed of 25 km/h is reached or when the user stops pedaling or cranking. The requirements are also met when the bicycle has an auxiliary drive in the sense of clause 1 which enables an acceleration of the vehicle to a speed of up to 6 km/h, even without simultaneous pedaling or cranking of the user (starting or pushing aid).

It becomes clear from this that certain pedelecs (with and without starting aid) are also considered as a bicycle and are therefore subject to the legal regulations for bicycles. Therefore, they are allowed to use the cycle path and do not require license plates.
two-wheeled and three-wheeled moped and light quadricycle (current driver’s license class AM): these are vehicles which can be operated substantially purely using muscular force or using muscular force and electric assistance (s-pedelec) or purely with electric assistance (e-bike), but with a maximum speed limited to 45 km/h. These include:
   s-pedelecs which assist the user up to a speed of approximately 45 km/h (with a maximum power output of 500 W) and e-bikes which can also operate independently, that is to say without peddling, with a maximum speed of approximately 45 km/h (with a maximum power output of 4000 W). These are therefore already considered to be mopeds, for which a driver’s license is required. These vehicles are not allowed to use the cycle path and require a license plate.
   e-bikes which can also operate independently, that is to say without pedaling, and for which in turn a maximum speed of 25 km/h is permitted and for which likewise a driver’s license or a moped test certificate is necessary. These vehicles are allowed to use a cycle path only if it is open to e-bikes, and require a license plate.

All the stated maximum values for speeds and power output are currently valid numbers and can change over time. Therefore, they are intended merely as a current definition aid.

In the following text, the abovementioned vehicles of pedelec, s-pedelec and e-bike are combined under the term electric bicycle within the context of the respective valid current legal requirements. Should the maximum permitted speed or the maximum permitted power output or other rules therefore change, they are incorporated correspondingly into the definition.

Different regulations therefore apply to electric bicycles as to which road types they are allowed to use. The use of highways is not permitted in the case of any type of electric bicycle, since they do not reach the minimum speed of currently 60 km/h.

Mobility solutions are already known which function on the basis of an electric bicycle, but have further features and/or pursue other targets. They are frequently equipped with a roof and some comfort features and can also have three or four wheels. It is an advantage of these vehicles that they require less space for parking on account of their small size. These mobility solutions are designed to preferably be operated within city limits, but have to be operated on the street and are frequently also not permitted on highways on account of their low maximum speed. Moreover, these mobility solutions are not allowed to be operated on bicycle paths.

It would be advantageous to provide a mobility solution which is allowed to be used on any paths and roads, that is to say both on a bicycle path and on the highway. For this purpose, it is necessary for the mobility solution, that is to say the vehicle, to be of flexible and/or adaptive design with regard to its drive, its identification (license plate obligation) and its equipment, that is to say for it to be possible for it to be adapted to current conditions, in particular during the journey. In order to implement the adaptation, a corresponding method for adapting (adaptation) the vehicle type is also to be provided.

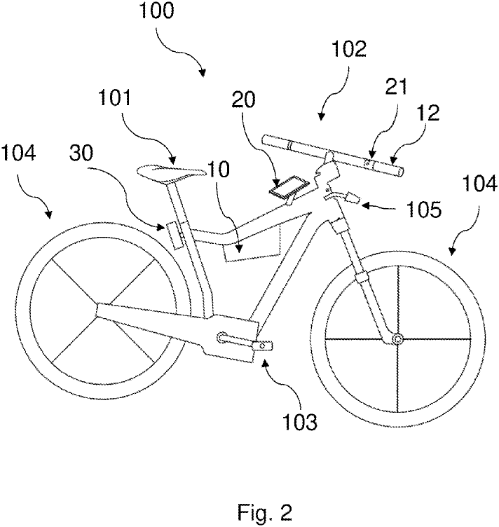

In the following text, the vehicle of the novel mobility solution will be described using FIG. 2.

The vehicle 100 is preferably a single-track, two-wheeled vehicle 100 in the form of a bicycle, that is to say with at least one seat, for example a saddle 101, and a handlebar 102. Here, it can have a drive which is actuated using muscular force in the form of pedals 103 or a hand crank which can also be capable of being fixed and therefore serve merely as a support or footrest. Furthermore, the vehicle 100 has a mechanically operated drive, preferably an electric drive 10, which is operatively connected to at least one wheel 104 of the vehicle 100 and can drive this wheel 104. The electric drive 10 can be operated by the user of the vehicle 100, in order to set the speed of the vehicle 100. This can be configured by way of a hand throttle which is provided, for example, as a twist grip 12 on the handlebar 102, or as a foot throttle. Furthermore, the power output can be set in the case of the electric drive 10, the maximum power output being so high that the vehicle 100 is allowed on the highway, that is to say it can reach at least 60 km/h (current status).

The vehicle 100 can fundamentally also have three or four wheels and one or more seats. Its width is advantageously smaller than the permissible vehicle width on the road types which are provided for use. In one advantageous embodiment, the width is such that the vehicle 100 may be used on cycle paths.

Furthermore, the vehicle 100 has a control device 20 which is attached releasably or fixedly either on the vehicle 100 as a separate device, or it being possible for a mobile device of the user to be arranged on a holder provided for this purpose on the vehicle 100, and a corresponding software function (app) assuming the functions of the control device 20, that is to say being operatively connected to an/or in a communications link with the devices of the vehicle 100. In the following text, a device of the user and also a separate device are therefore called a control device 20. The control device 20 serves as a navigation unit which can both detect the current position of the vehicle 100 and can also carry out a route calculation from a start point A to a destination point B. Furthermore, the vehicle types which the vehicle 100 can assume are stored in the control device 20, with the result that a suitable route selection can take place based on this information. Furthermore, the control device 20 has a communications link to the electric drive 10 and transmits control signals to the latter for carrying out the method which is described in the following text. The control signals are substantially such that they stipulate a restriction or enabling of the motor power output and the (permitted) maximum speed which can be achieved at most by the vehicle 100, and the drive 10 implements this accordingly. Furthermore, the control device 20 has a communications link with the display unit or units 30 and transmits control signals to it/them for carrying out the method which is described in the following text.

The control device 20 advantageously has a possibility for (as far as possible biometric) identification of the user, for example a fingerprint scanner and/or a retina identification means. This can serve to identify a user, that is to say also his/her preset preferences, usual routes, authorizations (driver’s license, etc.) which restrict the possible vehicle types, age, etc., if available.

Furthermore, a monitoring device 21 can be provided, on which it is displayed which maximum speed the vehicle 100 is allowed to currently travel at and/or which vehicle type it currently represents. The setting as a rule takes place by way of the control device 20, since this precisely knows the currently permitted speed and/or the vehicle type to be represented by the position of the vehicle 100 and existing or retrieved map information. That is to say, the control device 20 is also operatively connected to the monitoring device 21, in order that the latter can display the current setting.

A confirmation device can also be provided to confirm the setting of the vehicle type and/or the maximum permitted speed which the control device 20 will perform or has performed. The confirmation device is advantageously part of the monitoring device 21.

Moreover, the monitoring device 21 can be operated by the user, for example when he/she wishes to perform a manual setting of the maximum permitted speed or of the vehicle type. That is to say, the electric drive 10 and further devices such as the display unit 30 can be controlled by manual actuation of the monitoring device 21. Here, the monitoring device 21 can control or display merely a maximum speed, or it can also be formed in such a way that it controls or displays the vehicle type. If it can control the vehicle type, not only the electric drive 10 is controlled, but rather also the display unit 30 which is described in the following text, as if a display of a license plate takes place. Moreover, lighting devices such as a lighting system of the display unit 30, front and rear light, etc. can be actuated. The monitoring device 21 can be provided as a rotatable element on the handlebar 102.

Furthermore, the electric drive 10 can be connected to the control device 20 in such a way that it can charge it. It also has an interface to the outside, in order to be charged itself.

Furthermore, the vehicle 100 has a display unit 30 on a rear region thereof. It is advantageously arranged slightly laterally next to and above the wheel 104. Depending on regulations, a further display unit (not shown) can also be provided on the front side of the vehicle 100. The at least one display unit 30 is attached in such a way that it corresponds to the legal regulations for license numbers. In order to carry out the method which is described in the following text, the at least one display unit 30 is formed in such a way that it can display a license plate if required, that is to say in the case where the vehicle 100 is operated as an electric bicycle or motor vehicle which requires a license plate. Otherwise, for example if the vehicle 100 is operated as a bicycle, no license plate is displayed, that is to say the license plate is concealed.

In order to display a license plate, there are two types of embodiment of the at least one display unit 30. In one embodiment, the at least one display unit 30 is formed as a classic number plate, that is to say, for example, made from sheet metal with numbers and/or letters and/or symbols printed on or stamped in. In this embodiment, the at least one display unit 30 is of foldable configuration, that is to say has a corresponding mechanism which can be moved in an automated manner by means of a suitable actuator. In this way, the license plate can be hidden by way of folding in and can be displayed by way of folding out. In another embodiment, the at least one display unit 30 is configured as a display. The display is preferably configured in such a way that it does not reflect and is readily visible in all weather conditions. In this way, the license plate can be shown or hidden. In addition, a lighting means is provided on the at least one display unit 30. This can be provided as a separate lighting means or, in the case of the display, can be integrated therein.

The vehicle 100 is fundamentally equipped in accordance with the current traffic regulations. It therefore has front and rear lights. One turn signal 105 (indicator) per side is either integrated into the front and/or rear light, or it is attached separately to the vehicle 100.

On account of its equipment and the possibility of adapting this to the desired vehicle type in an adaptive manner, the vehicle 100 can therefore be utilized both as a bicycle and as a moped up to a motor vehicle (in the case of a single-track vehicle 100, as a motorcycle). In order for it to be possible for the vehicle 100 to be utilized correspondingly, a method is provided which can be run as a computer program on the control device 20 and will be described in the following text.

The vehicle 100 can be formed both in the type of a bicycle and also as a roofed vehicle 100. It can be of single-track or multiple-track configuration, it advantageously having at most the width which is permitted for using cycle paths. It can have a single seat or multiple seats.

In the following text, the method for adapting the vehicle type of the vehicle 100 is described. For implementation, it is proposed for a best possible distance or route between a start point A selected by the user and the destination point B to be found. The best possible route depends on the selection and/or the preferences of the user. This user can select the shortest route, the route with as few expressways as possible, or a route with other criteria. For this purpose, map data are evaluated, as is also the case in previously known navigation devices.

In addition, instructions or information with respect to the route or with respect to route sections of the route are also determined, with the result that there is a knowledge for the entire route of where what type of vehicle 100 is allowed to operate. For example, one route section is a highway, that is to say only motor vehicles (no bicycles) with a minimum speed of (currently) 60 km/h are allowed, denoted as route 1a on the right in FIG. 1. Another route section is a cycle path or a bicycle path which is open to e-bikes, that is to say no motor vehicles are allowed, but also no vehicles which can move at more than 25 km/h or can be driven independently, denoted as route 1b on the right in FIG. 1. The last part of the route as far as destination point B can then be an urban road with a permitted maximum speed of 50 km/h, denoted as route 1c on the right in FIG. 1. This information is either already stored in the map data or can be input manually, or can be called up via an interface.

Up to now, the dilemma would be that the entire route la-1c is not allowed to be traveled using the same vehicle, not even with one of the above-described types of electric bicycle.

According to the adaptive mobility solution of the present embodiment, however, it is possible for the route to nevertheless be traveled using a single vehicle 100. On account of the known route and the knowledge as to which vehicle type is permitted for each route section, the vehicle type is adapted correspondingly for each route section. That is to say, the full power output of the drive 10 is enabled for the route 1a (highway), that is to say a speed of at least 60 km/h can be used, and a license plate is displayed. For the route 1b (cycle path), the vehicle type is once again adapted. If e-bikes are allowed there, the drive 10 is correspondingly reduced, with the result that the vehicle 100 can be operated as an e-bike with the maximum top speed (currently 25 km/h) permitted for cycle paths. Furthermore, a license plate is displayed. If the cycle path is not open to e-bikes, the vehicle 100 is operated as a pedelec, that is to say with muscular drive assisted merely by the electric drive 10 via pedals 103, for example. It can also be possible for the vehicle 100 to be operated as a pure bicycle, the drive 10 being switched off for this purpose or being set into a recuperation mode. In this way, both the energy store of the drive 10 can be charged and training for the user can take place. This last vehicle type is advantageously requested merely manually by the user, or it is stored in his/her profile that this vehicle type can likewise be selected. Here, for example, the monitoring device 21 can serve for selection or the confirmation device can serve for confirmation in the case of an automated selection.

If the vehicle 100 does not have any pedals 103 or a hand crank, that is to say cannot be operated purely using muscular force, this has to be taken into consideration by the control device 20 in the route selection just like the authorizations of the user, since pure cycle paths may possibly then not be used, but rather only those which are open to e-bikes.

The drive is advantageously an electric drive 10 and has a rechargeable energy store for supplying the electric motor, but can also be a drive by means of gasoline, diesel, hydrogen or other energy types.

The motor power output is selected in a manner which is dependent on the traveled route section, that is to say, for example, is throttled correspondingly to the maximum permitted motor power output for a traveled route section of the route, with the result that the mobility solution can be used as an e-bike (without muscular assistance by way of pedaling/cranking). As an alternative, the motor can be switched on only with assistance by pedaling of the rider for a traveled route section, and the motor power output can be throttled. The mobility solution can thus be operated as an (s-)pedelec. For other route sections, the motor power output can be increased, with the result that the vehicle 100 is considered to be a motor vehicle, and highways may therefore also be used. In this way, new possibilities are opened up to travel from one location to a next location without changing the means of transportation, since both highways and also bicycle paths (possibly with restrictions) may be used with the same vehicle 100.

A basic mode of the vehicle 100 can comprise settings, in which the vehicle 100 is configured as a pedelec. In this way, the vehicle 100 can be operated by any person. In order to use the vehicle 100 as an adaptive mobility solution as described above, it is advantageously provided that an authorization enquiry takes place as to whether the user has a corresponding driver’s license and/or a permit and of what type, for example by these documents being read into a corresponding device or being scanned by it. Furthermore, a biometric identification can take place, for example by way of fingerprint and/or retina scan. Here, a defined profile can be stored for each user in the control device 20, for example frequently traveled routes, preferred road types, etc., and can be proposed to him/her.

In this way, corresponding restrictions of the drive 10 of the vehicle 100 can be performed, for example such that the user may not use the vehicle 100 as an s-pedelec or in an even higher configuration, that is to say, for example, for use on highways. Enabling of an authorization of this type advantageously takes place by way of reading in of the driver’s license and after recognition that the user has at least a passenger car driver’s license. The authorization can also take place via reading in of a permit; for example, the identity card or another authorization card can serve as this. This can also be appropriate even if the driver’s license is not, for example, machine-readable or there is even no driver’s license present as, for example, in the case of a child or frequently also a youth (if this youth does not have a moped permit, for example). Here, a corresponding authorization enquiry can be used to detect that, for example, a youth does not have a driver’s license, with the result that the vehicle 100 enables merely the basic function, in which it can be used as a pedelec. If he/she has a moped permit, this configuration is enabled. As a result of the enquiry of the authorization of the user, the vehicle 100 can be used by multiple people with different authorizations. It can therefore be used, for example, within a family of different people, but also by several people who do not know one another, and also as a company vehicle, leased vehicle or rental vehicle.

This authorization enquiry can take place not only by way of an enquiry by the driver’s license and/or a permit having to be read in. As an alternative, an automatic detection of a person, for example by means of sensors on the vehicle 100, and a comparison with corresponding stored data can also take place.

In order to be allowed to operate on different roads and paths, certain requirements have to be fulfilled. For example, a license number (number plate) has to be present or not depending on the type of route section which is traveled. Since the vehicle 100 may operate on all types of roads and paths (at least those which are open to bicycles), the number plate has to be adapted depending on the currently used road or path. That is to say, for example, no number plate is displayed if the vehicle 100 is operated as a pedelec, and a small or a normal number plate is displayed depending on whether the vehicle 100 is used as an e-bike or as an s-pedelec or an even faster vehicle 100, and is therefore considered to be a motor vehicle. Here, the actuation of the adaptation likewise advantageously takes place by way of the same method or in the same control device 20 which defines or determines the route to be traveled and the regulations there for each route section. Depending on the type of display unit 30, an actuator can then be actuated for mechanically changing the number plate, for example by way of folding away, or a display can be actuated for digital display.

Furthermore, in a further embodiment, either a lesser functionality or merely the basic function is permitted or throttled back if no clear or unambiguous detection of the predefined regulations for traveling the route section or the authorization of the user takes place. A warning can take place here during travel, with the result that the user can prepare for the change in the settings or can correct these manually, for example via the monitoring device 21.

The vehicle 100 is a vehicle 100 with two, three or four wheels for one or more persons, of which only one can be the operator (= user), the authorization of which then determines the configuration of the vehicle 100. Moreover, the vehicle 100 has all safety devices and other devices for fulfilling all regulations for operating on any roads. That is to say, a corresponding lighting system, an occupant protection system, for example airbag/airbags and/or safety belt system, rollover bar, etc., driver assistance systems such as an emergency call assistant, an emergency brake assistant, stability control systems, etc. can be provided, depending on official regulations. This also means, however, that the vehicle 100 has to adhere to the permissible widths for single-track or multiple-track vehicles and possibly permissible regulations with regard to the width and other dimensions in order to be allowed to operate on cycle paths.

Moreover, the vehicle 100 has a display unit 30 for automatically changing or digitally displaying a number plate (license number), in order for it to be possible to fulfill the regulations for operating on different roads and paths. Depending on the type of route section 1a-1c which is used, the number plate is adapted, either mechanically or digitally as described above.

In addition, it can be stipulated to wear a helmet for the use of a described vehicle 100 as an adaptive mobility solution. It can be provided here that wearing the helmet is monitored by the vehicle 100. If it is detected that a helmet would be stipulated for the current vehicle type but is not being worn, measures can be initiated, for example switching the vehicle 100 into a mode, in which no helmet has to be worn, or alerting/warning of the user.

As a result of the provision of an adaptive mobility solution which comprises both a corresponding method and an associated vehicle 100, further routes can be traveled using merely an electrically driven, bicycle-like vehicle 100.

Therefore, operation on all necessary road types such as paths, for example trail, cycle path, hiking trail, via urban road, rural road to highway, from start point A to destination point B is enabled technologically by way of activating or disabling of the necessary functionalities, in particular of the drive 10, and the corresponding display of a license plate.

Time-consuming changing from one vehicle type to another vehicle type can therefore be avoided and at the same time physical activity can take place. In addition, roads with a high proportion of passenger cars can also be avoided, since cycle paths, for example along rivers, etc., can be used which frequently also represent a shortcut. As a result of the versatile usability of the vehicle 100, fewer different vehicles are necessary in a family or in a business, for example in order to get from one premises to another. Less parking space is required as a result of the provision of the described vehicle 100. Moreover, the vehicle is sustainable, also because there are no CO₂ emissions, if it is operated electrically.

List of Designations

| A | Start point |
|---|---|
| B | Destination point |
| Z1, Z2 | Intermediate stops |
| 1, 2, 3 | Route section with a different mode of transport |
| 1a-1c | Route section with the same mode of transport, but in a different configuration |
| 100 | Vehicle |
| 101 | Saddle |
| 102 | Handlebar |
| 103 | Pedals |
| 104 | Wheel |
| 105 | Turn signal |
| 10 | Electric drive |
| 12 | Hand throttle |
| 20 | Control device |
| 21 | Monitoring device |
| 30 | Display unit |

1-15. (canceled)

16. A method for providing an adaptive mobility solution for a vehicle which can represent different vehicle types, the method comprising:
detecting a current position of the vehicle, and
calculating a route from a start point (A) to a destination point (B) such that specifications to fulfill permission for traveling the route or route sections thereof are determined therefrom, the route calculation taking place such that road types which are permitted for different vehicle types are not excluded, and
adapting the vehicle type, said adapting comprising adapting at least a drive and a display of a license plate, in a manner which is dependent on a route section of the route which is currently being traveled, such that the specifications determined therefor for traveling the route section are fulfilled.

17. The method as claimed in claim 16, wherein adapting the vehicle type includes adapting the vehicle to a bicycle, an electric bicycle, or a motor vehicle.

18. The method as claimed in claim 17, wherein adapting the vehicle type includes controllably and selectively displaying or concealing a license number dependent on the route section which is currently being traveled and the specifications which are determined therefor.

19. The method as claimed in claim 18, wherein adapting the vehicle type includes adapting the vehicle type to a predefined setting in a case where the specifications to fulfill permission for traveling the route or route sections are not properly detected.

20. The method as claimed claim 19, wherein adapting the vehicle type includes adapting to one of a plurality of adaptation options, and wherein the adaptation options of the vehicle type of the vehicle are enabled or denied in a manner which is dependent on a determined authorization of a current user.

21. The method as claimed in claim 16, wherein adapting the vehicle type includes controllably and selectively displaying or concealing a license number dependent on the route section which is currently being traveled and the specifications which are determined therefor.

22. The method as claimed in claim 21, wherein displaying the license number includes displaying the license plate number in an analog or digital manner.

23. The method as claimed in claim 16, wherein adapting the vehicle type includes adapting the vehicle type to a predefined basic setting or to last, reliably detected specifications in a case where the specifications to fulfill permission for traveling the route or route sections are not properly detected.

24. The method as claimed claim 16, wherein adapting the vehicle type includes adapting to one of a plurality of adaptation options, and wherein the adaptation options of the vehicle type of the vehicle are enabled or denied in a manner which is dependent on a determined authorization of a current user.

25. The method as claimed in claim 24, wherein the vehicle type is set to a predefined basic setting which allows the vehicle to be driven without the determined authorization.

26. The method as claimed in claim 24, wherein driving of the vehicle is refused in the case where the determined authorization does not occur.

27. The method as claimed in claim 16, wherein adapting the vehicle type further comprises adapting the vehicle type responsive in part to current user confirmation of the adapting of the vehicle type.

28. An adaptive mobility apparatus having a vehicle which has at least two wheels, comprising:
at least one seat, a handlebar, and front and rear lights,
at least one mechanically operated drive which is operatively connected to at least one wheel of the vehicle, the at least one mechanically operated drive configured to drive the at least one wheel as a sole or auxiliary drive, wherein
the vehicle has properties configured to be adapted such that the vehicle can represent different vehicle types which are allowed to move on different road types,
wherein the apparatus further comprises:
a display unit configured to selectively display or conceal a license number,
a control device configured to carry out the method as claimed in claim 16,
wherein the control device
contains data regarding the vehicle types which the vehicle can represent,
has a communications link to the drive and is configured to transmit control signals to the drive in order to adapt an operation of the drive, and
has a communications link to the display unit and transmits further control signals to the display unit in order to selectively display or conceal the license plate, and
serves as a navigation device for the route calculation.

29. The adaptive mobility apparatus as claimed in claim 28, wherein:
the display unit selectively displays or conceals the license plate mechanically by means of an actuator which can be actuated by the control device.

30. The adaptive mobility apparatus as claimed in claim 28, wherein:
the display unit comprises a digital display on which the license plate is selectively displayed or concealed.

31. The adaptive mobility apparatus as claimed in claim 28, wherein the drive comprises an electric drive configured to:
be operated by means of a hand or foot throttle, and/or
supply electrical energy to one or more of a group comprising the control device, the display unit, and a lighting system of the vehicle.

32. The adaptive mobility apparatus as claimed in claim 28, wherein the control device is arranged on a front region of the vehicle in a field of vision of a user, and wherein the control device includes:
a separate control device, or
a mobile device of the user serving as control device.

33. The adaptive mobility solution as claimed in claim 28, wherein:
the front and/or the rear light are configured to operate as a turn signal, or
the vehicle includes a separate turn signal;
and/or the display unit comprises an integrated lighting system.

34. The adaptive mobility solution as claimed in claim 28, wherein a monitoring device, arranged in a field of vision of a user, is configured to:
serve as a display for which the vehicle type and/or which a maximum permitted speed are/is currently set, and/or
provide for a manual setting of the vehicle type and/or the maximum permitted speed of the vehicle, and/or
serve as a confirmation means to receive user confirmation of the vehicle type which is currently proposed by the control device.

35. The adaptive mobility solution as claimed in claim 28, wherein:
the vehicle comprises a single-track or multiple-track vehicle with two, three or four wheels, and/or
a width of the vehicle is selected such that the vehicle does not exceed a maximum permitted overall width for traveling on cycle paths, and/or
the vehicle further comprises a canopy for protecting a user and/or the control device.
